(19) United States
(12) Patent Application Publication
(10) Pub. No.: US 2011/0226016 A1
(43) Pub. Date: Sep. 22, 2011

(54) DIAMOND EARRING WITH WASHER

(76) Inventors: Terrence Dashon Howard, Plymounth Meeting, PA (US); Michael R. Monahan, Minneapolis, MN (US)

(21) Appl. No.: 12/725,097

(22) Filed: Mar. 16, 2010

(51) Int. Cl. A44C 7/00; A44C 17/00; A44C 17/02; A44C 17/04; A44C 27/00; B23P 5/00

(52) U.S. Cl. 63/12; 29/10

(57) ABSTRACT

A post is formed of diamond with a gemstone integrally formed with the post. A washer formed of diamond has a hole for being supported by the post such that the washer is held between the gemstone and a body part when worn on the body part.

### FIELD

The present invention relates to the jewelry art, and specifically to jewelry made from a diamond.

### BACKGROUND

Diamonds have long been viewed as the symbol of eternal love and therefore associated with marriage through the use of diamond engagement rings and wedding rings.

The prior art is replete with jewelry that includes diamonds, such as wedding bands, engagement rings, and earrings. Diamond earrings for a pierced ear typically include a diamond with a metal post attached to the diamond. A metal clasp or back, sometimes referred to as an earnut, retentatively fits over the post to secure the earring to the ear.

### BRIEF DESCRIPTION OF THE DRAWINGS

FIG. 1 is a perspective view of a diamond band according to an example embodiment.

FIG. 2 is a front elevation view of the diamond band of FIG. 1.

FIG. 3 is a top view of the diamond band of FIG. 1.

FIG. 4 is side view of a portion of a diamond band having facets according to an example embodiment.

FIG. 5 is a top view of a diamond band having an embedded gemstone according to an example embodiment.

FIG. 6 is a top view of a diamond band having a gemstone in a setting according to an example embodiment.

FIG. 7A is a side elevation block representation of a diamond earring according to an example embodiment.

FIG. 7B is a side elevation block representation of an alternative diamond earring according to an example embodiment.

FIG. 8A is an exploded perspective view of a diamond earring according to an example embodiment.

FIG. 8B is a perspective view of yet a further diamond earring according to an example embodiment.

FIG. 9 is an enlarged perspective view of an earnut of the earring of FIG. 8A.

FIG. 10A is a side elevation view of a post of the earring of FIG. 8A.

FIG. 10B is a cross section view of a post of the earring of FIG. 8A.

FIG. 11 is a top view of a washer of the earring of FIG. 8A according to an example embodiment.

FIG. 12 is a top view of an alternative washer of the earring of FIG. 8A according to an example embodiment.

FIG. 13 is a top view of an alternative washer of the earring of FIG. 8A according to an example embodiment.

FIG. 14 is a top view of an alternative washer of the earring of FIG. 8A according to an example embodiment.

FIG. 15 is a top view of an alternative washer of the earring of FIG. 8A according to an example embodiment.

FIGS. 16A, 16B, 16C, 16D, 16E, and 16F are top views of various shapes of gemstones having posts according to example embodiments.

FIG. 17 is a perspective view of a washer and earrnut coupled by a diamond chain according to an example embodiment.

FIG. 18 is a side view of a post and a side view of a flexible earrnut for coupling to the post according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Various items of jewelry may be made from diamond. Some embodiments include a circular band made out of solid diamond. Further embodiments include multiple portions made out of solid diamond to form earrings, chains and other forms of jewelry.

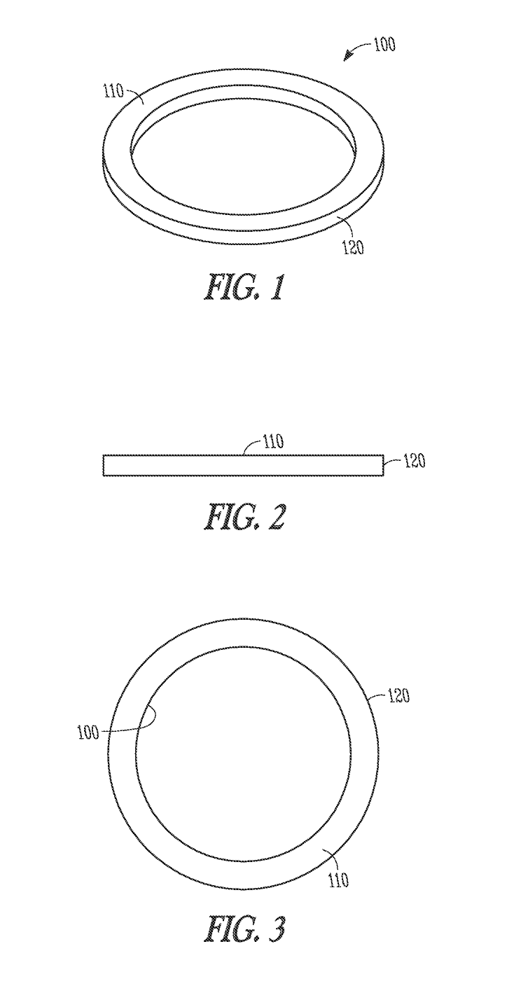

FIGS. 1, 2 and 3 show an example diamond band or ring 100. The band 100 is made of solid diamond in one embodiment, and may form a ring or bracelet. The band may be circular, oval, polygonal, or may be formed as a racetrack type pattern or may consist of various combinations of curved and polygonal portions. In some embodiments, the band may not be continuous, and may have a gap. The band may be worn on a body part, such as finger, wrist, neck, ankle, or other body part.

The term diamond is used to describe crystallized carbon. The present invention can be made of any of the commonly known types of diamond including the 4 types, known as type 1a, 1b, 2a, and 2b.

Diamond is comprised made mostly of carbon, and can be extremely pure. In almost all diamond material, however, there exists some portion of other elements, interspersed within the carbon as part of their crystal structure. These “impurities” are not what are commonly known as inclusions, visible to the naked eye or via magnification. These impurities are so subtle they may not even be visible under a very powerful microscope. Diamond material used to make the embodiments described herein are likely to contain some amount of other elements, or impurities.

The presence of other elements or combination of elements in diamond can give the diamond material a colored appearance. Various embodiments may be made out of diamond material having impurities such that it appears colored, including diamond material known as fancy colored diamond.

Diamond material is available from a number of sources. Diamond material may be mined from the earth or synthesized in a laboratory. Various embodiments may utilize diamond material from any source, as long as that material can be cut into a solid piece of diamond as described herein.

There are many diamond cutting techniques known in the art. Embodiments may be made utilizing any of the presently known cutting techniques. One of the methods used to create solid diamond jewelry include laser cutting solid diamond shapes out of a sheet of diamond made using a chemical vapor deposition process. Such a sheet of diamond may be formed as a single crystalline sheet using plasma assisted chemical vapor deposition. In further embodiments, the diamond may be formed by high pressure high temperature methods.

In one embodiment, the band 100 is substantially circular in shape, with straight sides. It may be cut from a sheet of diamond that is polished flat on both sides of the sheet. The sides of the sheet form the edges of the band 100 as indicated at 110. The inner edge 115 of the band 100 may be smooth in one embodiment, or may include a series of straight cuts by laser or other cutting device. In one embodiment, a large number of straight cuts may be used to form the inner edge of the ring to avoid potential discomfort of a wearer. In addition, a large number of cuts, such as 500 or more, may appear smooth or perfectly circular to a casual wearer. The inner edge defines a band or ring size, which may be customized to individual wearers in one embodiment.

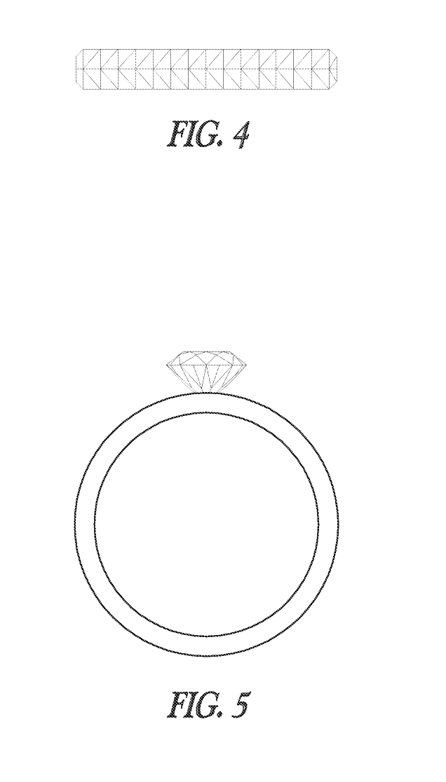

An outer edge 120 of the band 100 may also be smooth, or consistent of a series of straight cuts similar to the inner edge 115. In further embodiments, such as shown in a partial view of a band in FIG. 4, an outer edge and sides of the band may include one or more facets 410 cut into the band to enhance the amount of light reflected by the band and give the ring the appearance of a cut gemstone. The facets may be formed along some portion or the entirety of the piece of diamond material.

In one embodiment as shown in FIG. 5, a diamond band 500 includes, as an integral component, a portion that appears to be a separate gemstone 510. The gemstone may be formed to appear to be part of the band, extending from the band to feature the gemstone. The gemstone 510 may have any type of cut desired, such as round brilliant, having a base that appears embedded into the band.

In further embodiment in FIG. 6, diamond material may be cut to include a setting 610 on a band 600, to appear as a traditional diamond solitaire engagement ring. The ring 600 appears as a band with a gemstone setting at some point on the band. Many different settings may be cut from the diamond material in various embodiments. The diamond material may be rotated to different angles to accomplish the cuts to form such settings and gemstone combinations. Rings or bands incorporating a gemstone may be smooth or faceted in various embodiments. As shown in FIG. 6, the band has been cut and/or polished to give it a rounded appearance line a metal ring.

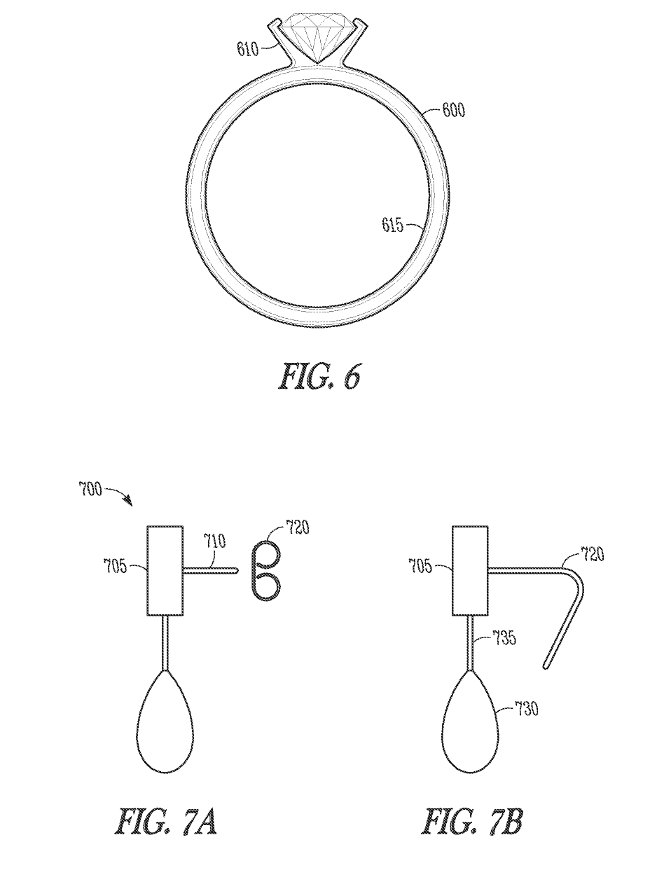

FIG. 7A is a perspective view of a diamond earring 700 according to an example embodiment. The diamond earring 700 in one embodiment is formed entirely of diamond. One example earring 700 includes a first portion 705 having a post 710 for insertion into a hole in a body part of a wearer, such as an ear or other portions of the body. A separate clip 720 formed of any desired material may be used to fasten the earring 700 via the post 710. In a further embodiment illustrated in FIG. 7B, the post may be curved to form a loop 720 such that the earring may be held in place by gravity.

In some embodiments, the post 710 is reinforced with another material, such as platinum or gold, or any other material that may provide strength and durability to the post to reduce the chance that the post may break. The reinforcing material may be formed on one or more sides of the post 710, and may coat the post in some embodiments. The reinforcing material may be deposited on the post using chemical vapor deposition, or in some embodiments, the post 710 may be dipped in a liquid form of the reinforcing material, such as heated metal. Further material may include glass, epoxy, glue, or other material suitable for enhancing the strength and durability of post 710. Such materials should be compatible with skin contact, and not cause undue skin irritation in some embodiments.

The first portion 705 may be formed in the shape of a gemstone in one embodiment, and may have a further a second portion 730 formed integral with the first portion 705. The second portion 730 may be a portion with a distinct design separate from the first portion, or may be of a similar design, but appearing separate from the first portion such that a viewer would not consider them as forming a single gemstone. In one embodiment, the first and second portions may be joined by a rod 735 or other structure between the two portions. A diamond chain may be used as a connecting portion in one embodiment. The rod itself may be considered a portion or joining portion that joins two main portions together. In one embodiment, the portions may appear as separate gemstones or separate design features. In further embodiments, a separate non-diamond, such as metal or plastic clasp for attaching to an ear may be attached to the earring.

Many further portions may be included, providing the ability to from an infinite number of different shapes of earrings, or other items of jewelry. In some embodiments, portions may be formed of interlocking loops to provide a chain or necklace appearance, and may be worn by a person. The loops may be fixed in relation to each other, or may be separate loops that are moveable relative to each other. The loops may be formed from a plate of diamond, rotating the diamond to form alternate loops, and freeing the loops from each other via one or more laser cuts from various angles. In further embodiments, selected portions of jewelry, such as posts in an earring, may be formed of other material if desired.

In one embodiment, a portion may be formed in the shape of an animal or insect, or other desired subject, including abstract art. As indicated above, the possibilities for design of a portion or connected portions may be infinite. In one embodiment, the set of designs may be limited by the size and shape of the starting material. When a plate of chemical vapor deposition diamond is used as a starting material, it is a block of diamond from which material is removed to form the jewelry. In one embodiment, if a ring with gemstone feature is being made, the ring will likely be cut primarily from the top of the plate, with an outline of the gemstone feature also being first cut from the top of the plate. In such an embodiment, the gemstone may not be larger than the thickness of the plate. Further, it will have a crystalline orientation that is defined by the crystalline orientation of the plate.

When a plate of single crystalline chemical vapor deposition diamond is used to form a band or other multi-component jewelry, the components will all have the same crystalline orientation, and may be perfectly matched in terms of color and clarity. Since such plates may be made with various colors, such as pink, blue or yellow, in addition to colorless to near colorless, the matching of the color among the components of the jewelry may provide for striking, all diamond, combinations formed into a wide array of different solid diamond items of jewelry.

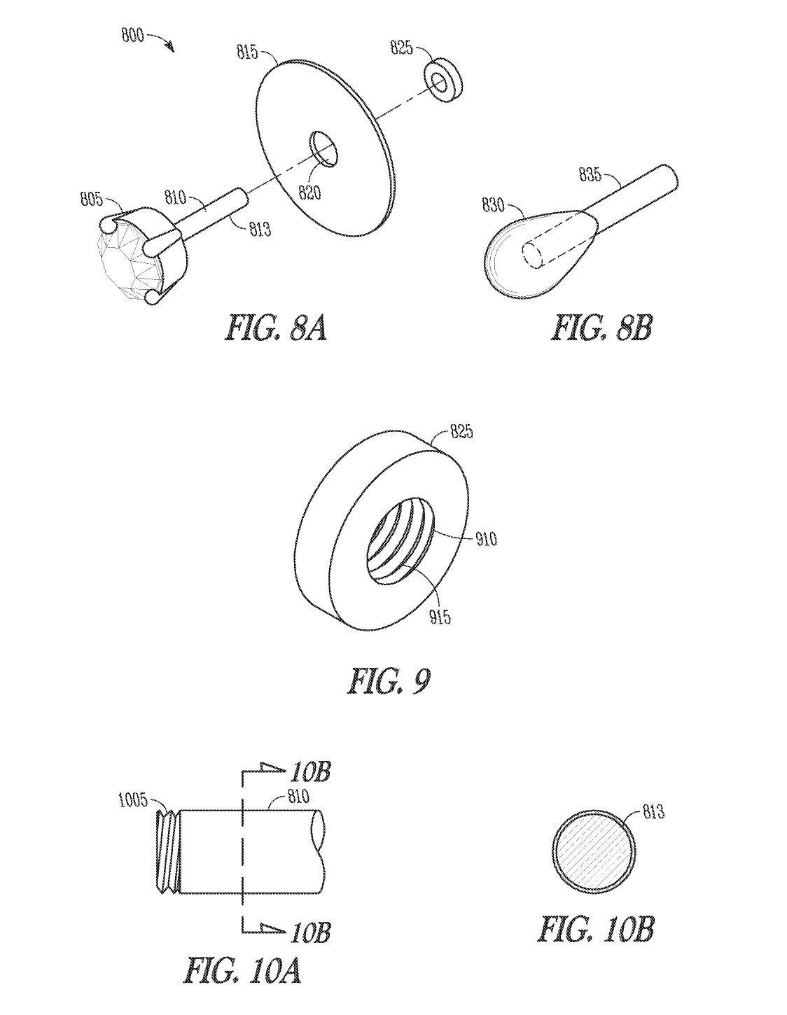

FIG. 8A is an exploded perspective view of a diamond earring 800 according to an example embodiment. A gemstone 805 is formed with a stud or post 810 shaped to fit through a hole in a pierced body part in one embodiment. The post 810 may be formed integrated with the gemstone 805. The combined post and gemstone may be formed from the same diamond, such as a plate of CVD formed diamond in one embodiment. While the gemstone 805 is shown in a setting with prongs, in some embodiments, the gemstone 805 is fully supported and integrated with the post 810 obviating the need for a separate setting with prongs.

In some embodiments, the post 810 may be coated or otherwise provided with reinforcing material 813 as described above. Various known processes may be used to coat the post with reinforcing materials. In some embodiments, the reinforcing material may at least partially cover a base of the gemstone 805 proximate the post 810. The reinforcing material may be formed of jewelry grade precious metals to enhance the appearance of the gemstone 805 in some embodiments. Example precious metals include gold, silver and platinum in various purities. The thickness of the reinforcing material may be varied depending on the thickness of the diamond material forming post 810. The overall diameter of post 810 with coating 813 in some embodiments is consistent with the diameter of standard posts for pierced body parts. In some embodiments, the reinforcing material is a metal coating formed as a threaded portion of the post for mating with an earnut 825 with mating threads, which may also be formed at least partially of metal or other suitable material for providing a post retaining function.

A diamond decorative washer 815 may be formed from the same CVD formed diamond plate or another plate or mined diamond. The decorative washer is formed with a hole 820 sized to accommodate the post 810. The post 810 may be inserted through the hole 820, and secured to the body part by an earnut 825. Gemstone 805 is formed large enough to prevent the washer 815 from slipping over the gemstone 805, such that the washer is secured 815 between the gemstone 805 and a body part when properly installed with the earnut 825. In one embodiment, the post 810 when attached to earnut 825 via mating threads, mating notches and protrusions, or other structures formed in diamond form a diamond upon diamond connective bond to secure the earring 800 to a selected body part. When inserted through an earlobe, the gemstone 805 and washer 815 may be situated on an outside part of the earlobe, with the post 810 extending through the earlobe and secured on the other side of the earlobe to the earnut 825. In this manner, the gemstone 805 and washer 815 form a decorative portion of the earring 800 that is visible to others.

In further embodiments, the reinforcing material may be formed on other portions of the diamond material in various forms, such as ring, washer, earnut, and earring to name a few. The reinforcing material may be used to strengthen the diamond structures, and may also be strategically positioned on selected portions or surfaces of the diamond material to enhance the appearance of the diamond when worn on an intended body part. For instance, the inner surface of a ring formed of diamond may be coated with platinum, as indicated at 615 in FIG. 6, to enhance the visibility and light reflecting properties of the ring.

FIG. 8B is a perspective view of a further gemstone 830 and post 835 arrangement. In one embodiment, the gemstone 830 is formed in a rain drop shape, with the post 835 extending from a top of the rain drop shape. The gemstone 830 and post 835 may be formed from a single piece of diamond in one embodiment, such that the post is integrated with the gemstone. Many different shapes of gemstones may similarly be formed with an integrated post, and may have one or more faceted portions.

In one embodiment, post 835 may be formed of a metal such as platinum, with the gemstone formed around the metal. The post may be formed first, and then coated with a diamond seed material, and the gemstone grown around the post using plasma assisted chemical vapor deposition techniques. The gemstone may then be cut into various shapes, such as by laser and polished as desired. In further embodiments, the rain drop shape may also have facets. In one embodiment, the entire metal post is covered with grown diamond.

The post 835 may be inserted through a washer of various shapes, such as a snowflake shape, and have threads or other attachment mechanisms to mate on the other side of a body part, such as a earlobe, with a suitable earnut 825, which may or may not also be formed of diamond, or metal, or diamond coated metal in various embodiments.

In further embodiments, the gemstones, posts and washers may be formed of different colored diamond that may form a set that can be mixed and matched to obtain a desired aesthetic appearance.

FIG. 9 is an enlarged perspective view of earnut 825. In one embodiment, earnut 825 is formed of diamond, and has an opening 910 to engage with the post 810. The opening 910 may be formed with threads 915, to engage with mating threads as indicated on post 810 in FIG. 10A, which is a side elevation view of post 810. Threads 915 may be formed by cutting via sawing or laser cutting. When formed via laser, the earnut 825 or laser is rotated, allowing the cutting of the threads from one or both sides of the earnut 825. In one embodiment, one, two or more complete or partially complete threads may be used to provide retention of the post when suitably engaged with mating thread 1005 on post 810. The threads 1005 may be formed in a similar manner to threads 915. In further embodiments, clasps like clip 720 may be used to retain the earring 800 in place when worn. A loop may also be used without an earrnut in further embodiments.

In further embodiments, earnut 825 may be formed of a different material such as metal, or diamond reinforced with metal to increase its strength and ability to hold the post securely. FIG. 10B is a cross section showing post 810 with optional coating 813.

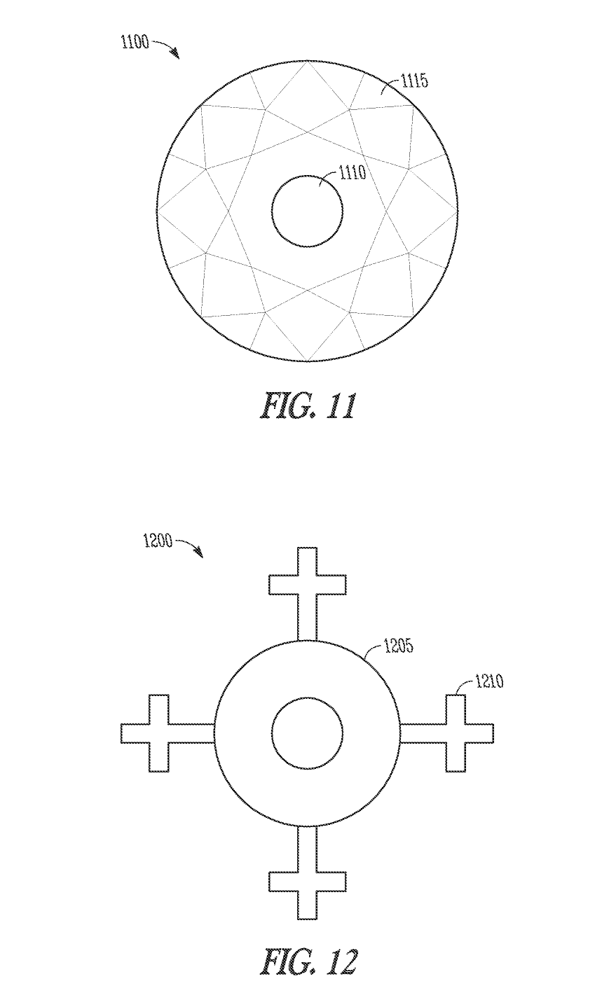

FIG. 11 is a top view of a washer 1100 of the earring of FIG. 8 according to an example embodiment. Washer 1100 may be formed of diamond in one embodiment as described above. Washer 1100 has a hole 1110 for accommodating the post 810. In one embodiment, washer 1100 may be formed in a circular shape with multiple facets to provide for internal reflection of light. Washer 1100 may take many different shapes and designs, rivaling the number of different shapes of snowflakes. As indicated above, washer 1100 may also be at least partially coated with metal to enhance its strength and light reflecting properties.

When CVD plates are used to form the earring 800, including washer 1100, the plates may be fairly large plates, exceeding several centimeters on a side, and have a depth that is suitable for forming round brilliant cut diamonds of several carats in various examples. The depth is expected to increase over time, but currently, the length and width of the plates is expected to exceed the depth for the foreseeable future. Washers having lateral dimensions exceeding 1 cm, 2 cm, 3 cms, or larger may be formed.

The inventors recognized an inherent limit in the ability to form jewelry from such plates, as at least one of three dimensions is somewhat limited. However, the use of a washer, such as washer 1100 expands the ability to create earrings having large surface areas. Such large surface areas that are essentially perpendicular to the gemstone portion of the earring provide unlimited design opportunities that can be striking in appearance due in part to their size when viewed from selected angles.

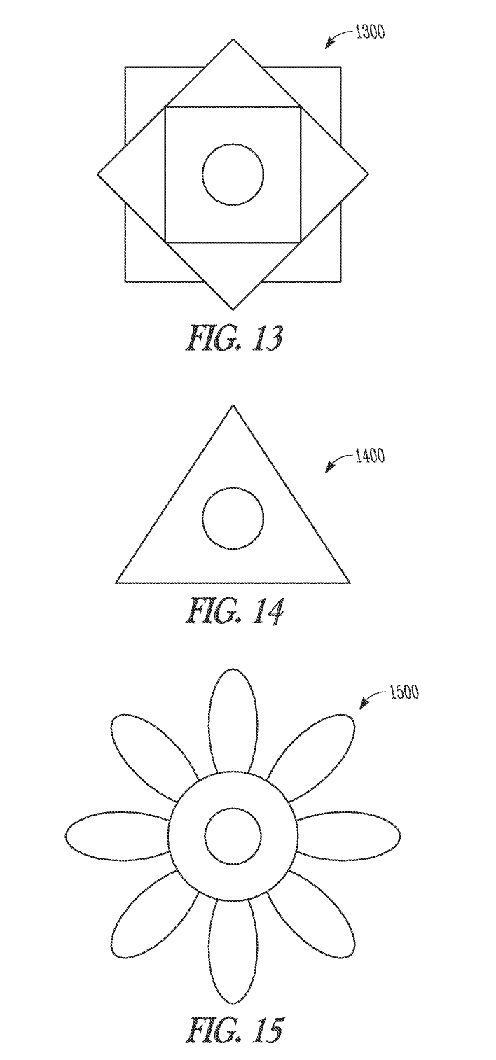

The washers may be cut in many different patterns as shown in the following FIGS. 12, 13, 14 and 15 at 1200, 1300, 1400 and 1500 respectively. Each washer contains a suitable hold for engaging with the post, and being retained by the gemstone. Facets may be cut into the washer to provide reflection of light and enhance the appearance as desired.

Washer 1200 has a circular center portion 1205 with multiple cross shapes 1210 cut from a CVD plate of diamond. The entire structure may be formed of single crystal diamond in one embodiment. Washer 1300 may be formed with a square shaped central portion with further intersecting square shapes. Washer 1400 may be formed as an equilateral triangle. These washers may take many geometric forms, such as polygons, and may also include curved portions as illustrated by washer 1500. These are just a few examples of the designs of washers that may be utilized in the earring 800. In some embodiment, multiple washers of varying sizes may be used on the same post 810 to provide even larger appearing diamond earrings. Facets may be used in any of the washers to enhance the use of light to increase and enhance the visibility and appearance of the washers.

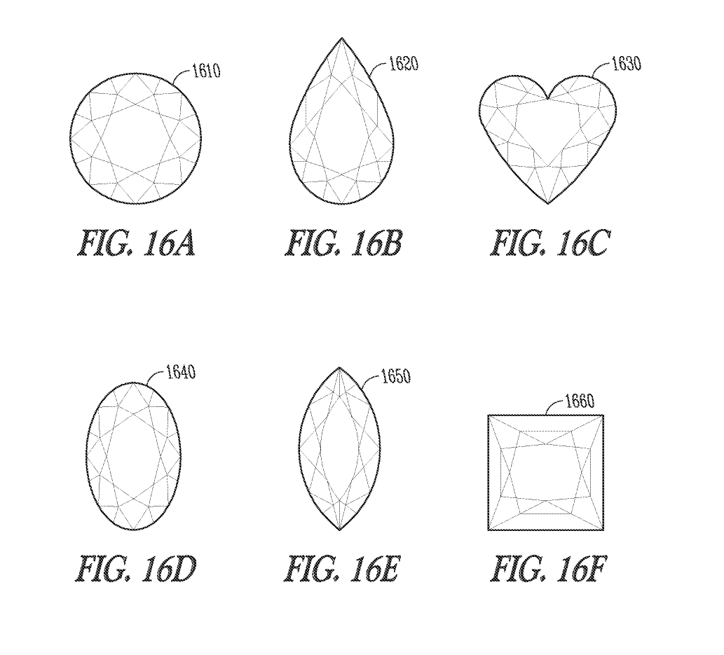

FIGS. 16A, 16B, 16C, 16D, 16E, and 16F are top views of various shapes of gemstones having posts according to example embodiments. A round shape is illustrated at 1610. Each of the gemstones illustrated may have multiple facets. A pear shape is illustrated at 1620, a heart shape at 1630, an oval shape at 1640, a marquis shape at 1650, and a princess shape is shown at 1660. Further shapes and cuts may be used in further embodiments. In further embodiments, the posts may be formed of diamond with integral settings for attaching one or more gemstones that may be independently cut and set in the settings. Such gemstones may be any type of precious or semi-precious gemstone as desired.

FIG. 17 is a perspective view of a washer 1710 and earrnut 1715 coupled by a diamond chain 1720 according to an example embodiment. In one embodiment, the washer, earnut and chain are formed from the same piece of diamond, resulting in them all being integral to each other. They all have the same crystalline orientation, color, and clarity in one embodiment when formed from the same piece of CVD formed diamond. In one embodiment, a reinforcing layer 725 has been added to the diamond washer 1710. The reinforcing layer may help strengthen the diamond washer and enhance the visibility of the washer. In further embodiments, links of the chain 1720 may be reinforced with metal or may be formed of metal.

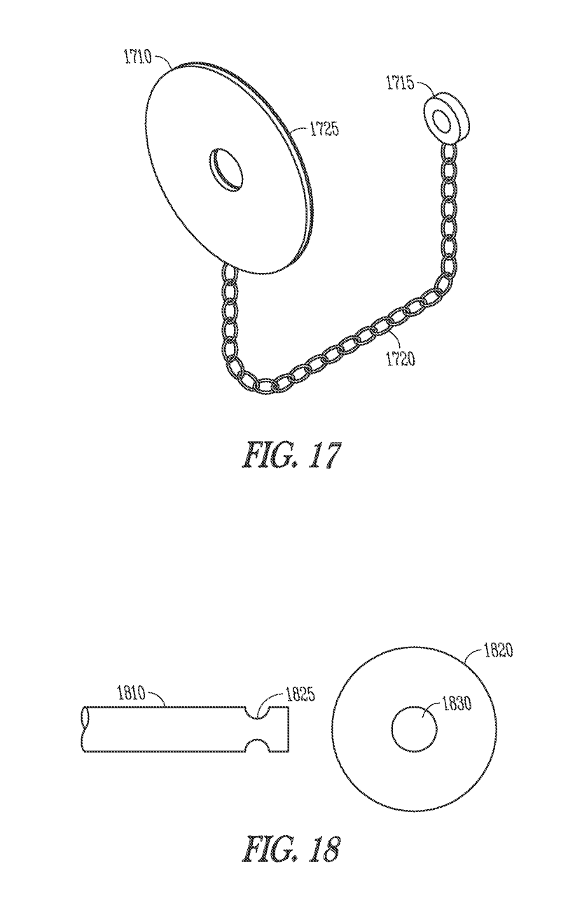

FIG. 18 is a side view of a post 1810 and a side view of a flexible earrnut 1820 for coupling to the post according to an example embodiment. In one embodiment, the post has an annular groove 1825 near an end opposite the gemstone, not shown. The flexible earnut 1820 has a hole 1830 that is sized to expand over the end of the post and engage securely in the groove 1825. The earnut 1820 has an outer perimeter that is sized to retain the post on a body part, while the other end of the post has a gemstone supports at least one washer formed of diamond. As with other embodiments described herein, each of the components of the earring may be formed of diamond.

This invention is intended to cover all changes and modifications of the example embodiments described herein which do not constitute departures from the scope of the claims.

What is claimed is:

1. An article comprising:
a post formed of diamond;
a gemstone integrally formed with the post; and
a washer formed of diamond having a hole for being supported by the post such that the washer is held between the gemstone and a body part when worn on the body part.

2. The article of claim 1 and further comprising an earnut to couple to the post.

3. The article of claim 2 wherein the earnut and post include mating threads.

4. The article of claim 2 wherein the post includes an annular groove and wherein the earnut has a flexible opening to retentively mate with the annular groove of the post.

5. The article of claim 1 wherein the washer has a diameter of at least 2 cm.

6. The article of claim 1 wherein the washer is formed of single crystalline CVD diamond.

7. The article of claim 1 wherein the washer is formed of CVD colored diamond.

8. The article of claim 1 wherein the washer includes multiple facets.

9. The article of claim 1 wherein the washer is polygonal in shape.

10. The article of claim 1 wherein the gemstone and post comprise single crystalline diamond having the same crystal orientation.

11. The article of claim 10 wherein the gemstone and post have the same color and clarity.

12. The article of claim 10 wherein the gemstone, post and washer have the same color and clarity.

13. The article of claim 10 wherein the post includes a reinforcing material.

14. The article of claim 13 wherein the reinforcing material is a metal coating an outside surface of the post.

15. The article of claim 14 wherein the metal coating is formed as a threaded portion of the post for mating with an earnut with mating threads.

16. The article of claim 15 wherein the earnut includes metal.

17. The article of claim 1 wherein the washer includes a partial metal coating.

18. An article comprising:
a post formed of diamond having integral prongs adapted to secure a gemstone; and
a washer formed of diamond having a hole for being supported by the post such that the washer is held between the prongs and a body part when the post is inserted through a hole in the body part.

19. The article of claim 18 and further comprising an earnut to couple to the post.

20. The article of claim 19 wherein the earnut and post include mating threads.

21. The article of claim 19 and further comprising a diamond chain coupled between the washer and the earnut.

22. The article of claim 18 wherein the washer has a diameter of at least 2 cm.

23. The article of claim 18 wherein the washer is formed of single crystalline CVD diamond.

24. The article of claim 18 wherein the washer is formed of CVD colored diamond.

25. The article of claim 18 wherein the washer includes multiple facets.

26. The article of claim 18 wherein the post and washer have the same color and clarity.

27. The article of claim 18 wherein the post includes a reinforcing material.

28. The article of claim 27 wherein the reinforcing material is a metal coating formed as a threaded portion of the post for mating with an earnut with mating threads.

29. The article of claim 18 wherein the washer includes a partial metal coating.

30. A method comprising:
forming a gemstone with integral post from a CVD formed diamond plate;
forming a washer from a CVD formed diamond plate, the washer formed with a hole adapted to engage the post; and
forming a feature on the post to couple to a retentive earnut.

31. The method of claim 30 wherein the gemstone with post and washer are cut from the same CVD formed diamond plate by use of a laser.

32. The method of claim 30 and further comprising forming multiple facets on the washer.

33. The method of claim 30 and further comprising cutting a featured gemstone as an integral part of the band from the plate of diamond.

34. The method of claim 30 wherein the post is formed to include a non-diamond reinforcing material.

35. A method comprising:
forming a first component from a plate of diamond; and
forming a second component integrally coupled to the first component from the plate of diamond.
